(19) United States
(12) Patent Application Publication
(10) Pub. No.: US 2002/0005674 A1
(43) Pub. Date: Jan. 17, 2002

(54) Reluctance type resolver with reduced detection error due to external magnetic flux

(75) Inventor: Yasukazu Hayashi, Niwa-gun (JP)

Correspondence Address: Oliff & Berridge PLC, P.O. Box 19928, Alexandria, VA, 22320, US

(73) Assignee: OKUMA CORPORATION, Nagoya-Shi (JP)

(21) Appl. No.: 09/887,015

(22) Filed: Jun. 25, 2001

(30) Foreign Application Priority Data
Jul. 10, 2000 (JP) 2000-208948

(51) Int. Cl. H02K 17/42; H02K 19/20; H02K 19/24; H02K 1/12

(52) U.S. Cl. 310/168; 310/254; 310/68 B

(57) ABSTRACT

To provide a reluctance type resolver which can reduce the influence by leakage magnetic flux and improve precision. A rotor 11, constructed from a magnetic material, includes magnetic salient sections opposing excitation teeth of a stator 31 and is fixed to an input axis 10, to be linked with the rotational motion of the input axis 10. Excitation teeth and bypass magnetic path teeth, both of which are constructed from a magnetic material, are provided on the inner periphery of the stator 31 with a predetermined spacing in between. Excitation windings are wound on the excitation teeth so that magnetic flux of the same direction with respect to the rotor 11 is generated at the excitation teeth.

### BACKGROUND OF THE INVENTION

1. Field of the Invention

The present invention relates to a reluctance type resolver used as a sensor for detecting the velocity and position of the motion of a rotor portion in a rotating or translating motor, and in particular, to reduction in detection errors generated by leakage magnetic flux from an electromotive rotor or electromagnetic brakes.

2. Description of the Related Art

FIG. 3 is a cross sectional diagram of a reluctance type resolver in the prior art, cut in the radial direction. FIG. 4 is a block diagram showing an example of a detection apparatus for detecting the rotational position from the reluctance type resolver depicted in FIG. 3. In FIG. 3, eight teeth 2, 3, 4, 5, 6, 7, 8, and 9 to be exited (referred to as excitation teeth hereinafter), constructed from a magnetic material, are positioned with equal spacing in between at the inner periphery of a stator 1. Windings 12, 13, 14, 15, 16, 17, 18, and 19 for exciting (referred to as excitation windings) are wound around the excitation teeth, one winding at each tooth. The winding are wound in a such manner that magnetic fluxes generated at the excitation teeth 2, 4, 6, and 8 are of opposite direction from the magnetic fluxes generated at the excitation teeth 3, 5, 7, and 9, and the overall sum of the magnetic flux through each excitation tooth is zero, when an excitation signal is input. A rotor 11 is constructed from a magnetic material. Eighteen salient sections are provided with equal spacing in between at the outer periphery of the rotor 11. Each salient section is placed to oppose the excitation teeth of the stator 1. The rotor 11 is fixed to an input axis 10 so that it can rotate with the rotational motion of the input axis 10. In such a reluctance type resolver, when the rotor 11 rotates, the gap between the salient sections of the rotor 11 and the excitation teeth of the stator 1 varies and the permeance, which is the magnetic resistance, of each excitation winding changes at a period of the pitch of the salient sections of the rotor 11. The permeance change with respect to the adjacent excitation winding has a phase which is different by ¼ pitch of the salient section.

In the detection apparatus of FIG. 4, the excitation windings 12, 16, 14, 18, 13, 17, 15, and 19 of the reluctance type resolver are excited by an excitation signal current SIN (ωt) from an excitation signal generator 20. The excitation signal generator 20 adjusts the waveform of a square wave signal EXP from a timing generator 30, to produce and output an excitation signal current having a sine waveform, SIN (ωt). The excitation windings, wound on opposing excitation teeth and having the same phase for permeance change, 12 and 16; 13 and 17; 14 and 18; and 15 and 19, are respectively connected in series and current detection resistors 21, 22, 23, and 24 are each connected in series to each pair of excitation windings. In this manner, the current flowing through each pair of excitation windings is detected as a voltage signal. Here, the voltage signals corresponding to the current flowing through each pair of excitation windings are respectively indicated by VCP, VCN, VSP, and VSN.

The excitation windings, wound on opposing excitation teeth and having the same phase for permeance change, are connected in series in order to reduce the influence on the precision of position detection in a case where the centers of the stator and the rotor do not coincide, by the averaging effect of two excitation windings.

The current flowing trough each pair of excitation windings, 12 and 16; 13 and 17; 14 and 18; and 15 and 19 changes in direct proportion to the permeance change in the windings. Therefore, when the rotational angle of the rotor 11 is represented by θ, and the coefficients of the rotor 11 are represented by α and β, the signals VCP, VCN, VSP, and VSN can be approximated by the following equations.

VCP=(α+β COS (14θ)) SIN (ωt) (1)

VCN=(α−β COS (14θ)) SIN (ωt) (2)

VSP=(α+β SIN (14θ)) SIN (ωt) (3)

VSN=(α−β SIN (14θ)) SIN (ωt) (4)

The pairs of signals VCP and VCN; and VSP and VSN are subject to a subtraction process at differential amplifiers 25 and 26, and are output, respectively, as signals VC and VS after operational amplification. These signals VC and VS can be approximated by the following equations (5) and (6).

VC=2β COS (14θ) SIN (ωt) (5)

VS=2β SIN (14θ) SIN (ωt) (6)

The signals VC and VS are converted into digital signals DC and DS by an AD converter 27 and 28 at a timing when SIN (ωt) becomes 1 by a conversion command signal CNV which is synchronized with the excitation signal from the timing generator 30. Thus, signals DC and DS can be approximated by the following equations (7) and (8).

DC=2 COS (14θ) (7)

DS=2 SIN (14θ) (8)

An interpolating calculator 29 digitally processes the digital signals DC and DS, to calculate the inverse tangent of two variables, and outputs the result as a signal PO. The calculation result of the inverse tangent of digital signals DC and DS is 14 θ, and thus, the signal PO corresponds to the rotational position of the input axis 10.

As described above, in the reluctance type resolver shown in FIG. 3, the position θ of the input axis can be detected with a sensitivity of 14 times, by a simple winding structure in which an excitation winding is wound around a tooth of the stator. Such a resolver capable of detecting the rotor position with a sensitivity of 14 times is called, in general, a 14X resolver. This number, “14”, is generally referred to as a “number of multiple”.

However, when the velocity and position of the motor rotor motion are to be detected using a reluctance type resolver shown in FIGS. 3 and 4, precise measurement is hindered by the influence of a leakage magnetic flux NF from the permanent magnet of the motor rotor or the electromagnetic brake, as shown by a dotted line in FIG. 5. In other words, the leakage magnetic flux NF changes with the variation of the gap between the salient sections of the rotor and the excitation teeth of the stator, and, thus, changes in direct proportion to the permeance change of each excitation winding. Because of this, when the rotor 11 rotates, the leakage magnetic flux through each excitation winding changes, generating a noise current in the excitation winding directly proportional to the derivative of the leakage magnetic flux.

Signals VCP, VCN, VSP, and VSN with the noise current considered can be approximated by the following equations, where the angular velocity of the rotating rotor is represented by v and the coefficient is represented by γ.

VCP=(α+β COS (14θ)) SIN (ωt)−14γv SIN (14θ) (9)

VCN=(α−β COS (14θ)) SIN (ωt)+14γv SIN (14θ) (10)

VSP=(α+β SIN (14θ)) SIN (ωt)−14γv COS (14θ) (11)

VSN=(α−β SIN (14θ)) SIN (ωt)+14γv COS (14θ) (12)

The signals VC and VS which are differences between the signals VCP and VCN and between VSP and VSN, respectively, can be approximated by the following equations (13) and (14).

VC=2β COS (14θ) SIN (ωt)−28γv SIN (14θ) (13)

VS=2β SIN (14θ) SIN (ωt)−28γv COS (14θ) (14)

From equations (13) and (14), digital signals DC and DS, sampled when SIN (ωt)=1 can be approximated by the following equations.

DC=2β COS (14θ)−28γv SIN (14θ) (15)

DS=2β SIN (14θ)−28γv COS (14θ) (16)

If δ is set equal to SQRT (4β·β+728 γ·γ·v·v), the equations (15) and (16) can be rewritten into the following equations using a well-known mathematical formula.

DC=δ COS (14θ+A TAN (14γv/β)) (17)

DS=δ SIN (14θ−A TAN (14γv/β)) (18)

As a result of the calculation by an interpolating calculator 28, of an inverse tangent of two variables for digital signals DC and DS shown in equations (17) and (18), the output signal PO can be represented by the following equation.

PO=14θ−A TAN (14γv/β) COS (28θ) (19)

Here, because 14γv is sufficiently smaller than β, equation (19) can be approximated and rewritten as,

PO=14 (θ+γv/β COS (28θ)) (20)

Generalizing equation (20) for an NX resolver having a number of multiple of N, we obtain the following equation (21).

PO=N(θ+γv/β COS (2Nθ)) (21)

Close examination of equations (20) and (21) shows that the influence of the leakage magnetic flux from the motor on the detection error of the position is directly proportional to the angular velocity v and the number of multiple N and produces a detection error of the position which vibrates 2N times for each rotation. When the number of multiple of the resolver is small, the frequency ω of the excitation signal is sufficiently high, and the velocity of the rotor is low, the noise component due to the leakage magnetic flux is in a low band, as can be seen from equations (13) and (14). Thus, the positional detection error can be removed by a high pass filter or the like. However, these days, there is a tendency to increase the number of multiple of the resolver in order to increase the resolution of the position detection, and, moreover, the rotor velocity in a motor is becoming faster and faster. Thus, removal of the noise by a high pass filter is becoming more and more difficult. Also, even when the error in detecting position is at a level which does not cause a significant problem, because the velocity detection is generally performed by differentiating the position detected value for controlling the velocity of the motor, the influence due to the leakage magnetic flux will be proportional to the square of the rotational velocity at the velocity error level, and thus, the influence of the leakage magnetic flux becomes serious when the motor is moved more rapidly.

### SUMMARY OF THE INVENTION

The present invention is conceived to solve the above problem and one object of the present invention is to provide a reluctance type resolver, with a winding structure that can be easily manufactured, that can perform high precision velocity detection and position detection without being significantly influenced by the leakage magnetic flux from the permanent magnet of the motor rotor or the electromagnetic brake.

In order to achieve the object mentioned above, according to one aspect of the present invention, there is provided a reluctance type resolver comprising: a stator, constructed from a magnetic material, having a plurality of excitation teeth, each of which is wound with an excitation winding; a rotor having magnetic salient sections that are placed to oppose the excitation teeth; and means for detecting the position of the rotor, by detecting a current or voltage of the excitation winding which changes with different phase in response to the motion of the rotor; wherein the excitation winding is wound on each excitation tooth so that the magnetic fluxes through all excitation teeth have the same direction; and the stator includes bypass magnetic path teeth where magnetic flux having a direction opposite to the passing direction of the excitation teeth. In this manner, bypass magnetic path teeth are formed, allowing the excitation windings to be wound in directions that are less prone to the leakage magnetic flux, thus improving the velocity detection precision.

According to another aspect of the present invention, the resolver comprises pairs of adjacent excitation teeth positioned in such a manner that the changes in magnetic resistance due to the motion of the rotor have the same phase. By connecting excitation windings wound around a pair of excitation teeth in series, the influence by the leakage magnetic flux can be cancelled out and the detection precision for velocity and position can be improved. In other words, according to this aspect of the present invention, there is provided a reluctance type resolver, comprising: a stator, constructed from a magnetic material, having a plurality of excitation teeth, each of which is wound with an excitation winding; a rotor having magnetic salient sections that are placed to oppose the excitation teeth; and means for detecting the position of the rotor, by detecting a current or voltage of the excitation winding which changes with different phase in response to the motion of the rotor; wherein each of the excitation windings is wound on each of the excitation teeth for a pair of adjacent excitation teeth such that the magnetic flux through each of the paired excitation teeth has directions opposite to each other, and the excitation windings for a pair of excitation teeth are connected in series; and excitation teeth are provided on the stator so that the pitch of each excitation tooth for each pair of adjacent excitation teeth equals an integral multiple of the pitch of the magnetic salient sections of the rotor.

### BRIEF DESCRIPTION OF THE DRAWING

FIG. 1 is a cross sectional diagram of a reluctance type resolver in the radial direction according to an embodiment of the present invention.

FIG. 2 is a cross sectional diagram of a reluctance type resolver in the radial direction according to another aspect of the present invention.

FIG. 3 is a cross sectional diagram of a reluctance type resolver, cut in the radial direction, according to the prior art.

FIG. 4 is a structural block diagram of a detection apparatus in a reluctance type resolver.

FIG. 5 is a descriptive diagram showing an example of a leakage magnetic flux incoming from the axial direction to the reluctance type resolver.

### DESCRIPTION OF PREFERRED EMBODIMENTS

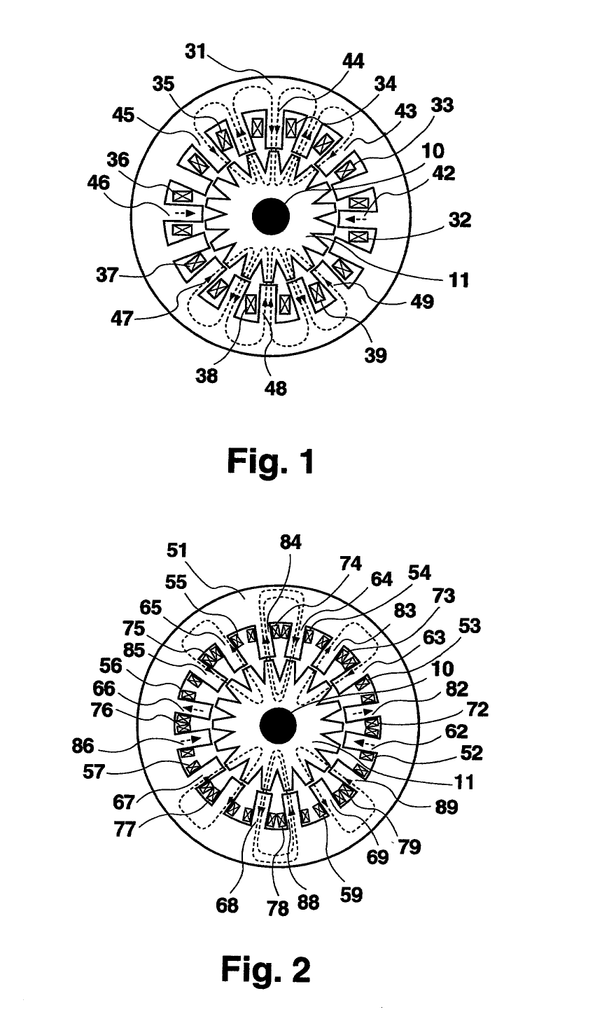

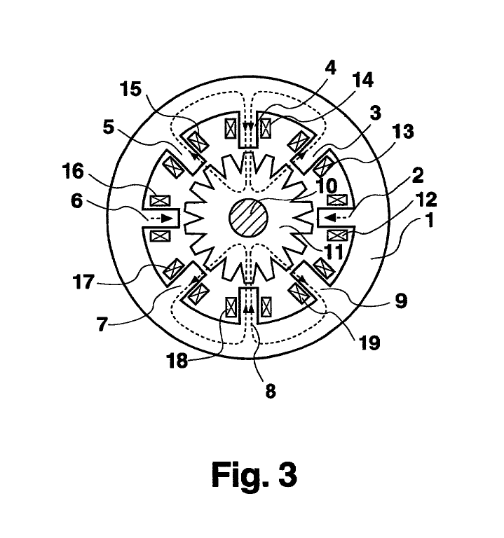

A preferred embodiment of the present invention will now be described referring to the drawings. FIG. 1 is a cross sectional diagram of a reluctance type resolver according to an embodiment of the present invention in the radial direction, taken along a cross section perpendicular to the axis. The structures identical to those shown in FIG. 3 are assigned the same reference numeral and will not be described again. Sixteen teeth that are constructed from a magnetic material are provided at the inner periphery of a stator 31. Of these, eight teeth 42, 43, 44, 45, 46, 47, 48, and 49 correspond to the excitation teeth. Each of excitation windings 32, 33, 34, 35, 36, 37, 38, and 39 are wound on each of the excitation teeth. The remaining eight teeth correspond to bypass magnetic path teeth. No winding is wound on the bypass magnetic path teeth. Moreover, four pairs of excitation windings, 32 and 36; 33 and 37; 34 and 38; and 35 and 39 are connected in series at the rotor 31. The excitation windings are wound so that the magnetic flux through the teeth 42, 43, 44, 45, 46, 47, 48, and 49 will have the same direction with respect to the rotor 11 when an excitation signal is input to the excitation windings. In this manner, when an excitation signal is input to the excitation windings, a magnetic flux having an opposite direction with respect to the rotor 11 than the magnetic flux through the excitation teeth 42, 43, 44, 45, 46, 47, 48, and 49 is generated at the eight bypass magnetic path teeth on which no winding is wound and provided between the excitation teeth, and thus, the bypass magnetic path teeth function as bypass magnetic paths.

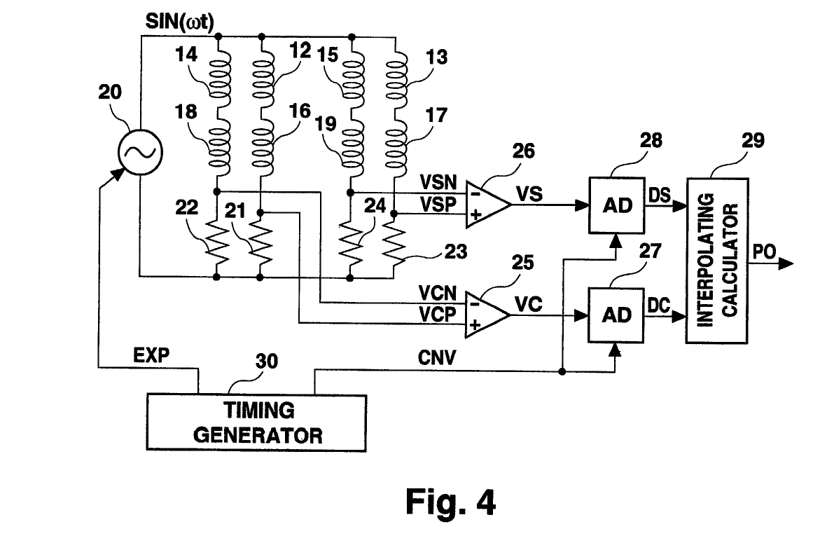

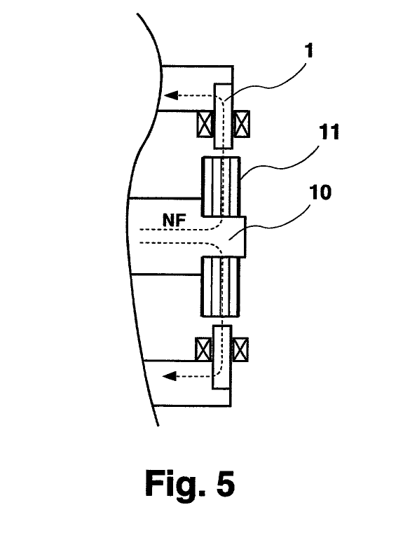

A case in which the position of the reluctance type resolver of FIG. 1 is detected using a position detection apparatus of FIG. 4, in the same manner as for the resolver of FIG. 3, will now be described. Four pairs of excitation windings, 32 and 36; 33 and 37; 34 and 38; and 35 and 39, respectively correspond to four pairs of windings, 12 and 16; 13 and 17; 14 and 18; and 15 and 19; in the prior art. The permeance change with respect to motion of the rotor 11 will be nearly equal to the prior art. In other words, the position of the reluctance type resolver shown in FIG. 1 can be detected using the position detection apparatus of FIG. 4, in a similar manner to the position detection for the resolver shown in FIG. 3. On the other hand, when a leakage magnetic flux NF as shown by dotted line in FIG. 5 is generated, the noise current generated due to the leakage magnetic flux in the excitation windings 33, 37, 35, and 39 will have a direction different from the noise current generated in the excitation windings 13, 17, 15, and 19. Thus, when the position, etc., is detected by the position detection apparatus of FIG. 4 for the reluctance type resolver of FIG. 1, the signals VSP and VSN can be approximated by the following equations.

VSP=(α+β SIN (14θ)) SIN (ωt)+14γv COS (14θ) (22)

VSN=(α−β SIN (14θ)) SIN (ωt)−14γv COS (14θ) (23)

The signal VS which is the difference between signals VSP and VSN is represented by the equation (24).

VS=2 SIN (14θ) SIN (ωt)+28γv COS (14θ) (24)

The digital signal DS, obtained by sampling VS according to equation (24) when SIN (ωt)=1, is represented by equation (25).

DS=2β SIN (14θ)+28γv COS (14θ) (25)

By letting δ equal SQRT(4β·β+728γ·γ·v·v), equation (25) can be rewritten into the following equation using a well-known mathematical formula.

DS=δ SIN (14θ+A TAN (14γv/β)) (26)

Signal DC is identical to that shown in equation (17). When the interpolating calculator 28 performs an inverse tangent calculation of two variables on the digital signals DC and DS, the output signal PO will be,

PO=14θ+A TAN (14γv/β) (27)

Because 14γv is sufficiently smaller than β in this case, equation (27) can be approximated to equation (28).

PO=14 (θ+γv/β) (28)

As shown in equation (28), the influence of the leakage magnetic flux for a case of position detection in the reluctance type resolver of FIG. 1 appears as an offset error of the position directly proportional to the rotational velocity, and no vibration component is generated. Because of this, the velocity detection value obtained by differentiating the detected position value will not be influenced by a velocity error due to the leakage magnetic flux. The offset error of the position which is directly proportional to the velocity is sufficiently small compared to the follower delay due to the position control etc. Thus, even when 14γv is much larger than β, the inverse tangent of the second term in PO, (Arctan(14γvβ)), does not exceed ±π/2, and, thus, sufficient precision can be achieved.

Another aspect of the present invention will now be described with reference to the drawings. FIG. 2 is a cross sectional diagram of a reluctance type resolver according to another aspect of the present invention, cut in the radial direction. In FIG. 2, the structures identical to those shown in FIG. 3 will be assigned the same reference numeral and will not be described again. As shown in FIG. 2, eight pairs of excitation teeth, 62 and 82; 63 and 83; 64 and 84; 65 and 85; 66 and 86; 67 and 87; 68 and 88; and 69 and 89 are provided at the inner periphery of the stator 51, each pair comprising two adjacent excitation teeth. The pairs of excitation teeth are placed with equal space in between, and two excitation teeth composing a pair are placed so that the spacing (pitch) between the two teeth is equal to an integral multiple of the pitch of the salient section of the rotor 11. In this manner, the permeance between the paired excitation teeth and the rotor 11 changes with the same phase. Excitation windings, 52 and 72; 53 and 73; 54 and 74; 55 and 75; 56 and 76; 57 and 77; 58 and 78; and 59 and 79 are wound on eight pairs of teeth, 62 and 82; 63 and 83; 64 and 84; 65 and 85; 66 and 86; 67 and 87; 68 and 88; and 69 and 89. Two excitation windings for a pair of excitation teeth are connected in series. When an excitation signal is input on the excitation windings, magnetic fluxes are generated at the two paired excitation teeth, having opposite directions to each other with respect to the rotor 11. As a result, in the resolver shown in FIG. 2, two excitation teeth in each pair have the same phase for magnetic resistance change with respect to the motion of the rotor 11 and the total sum of the magnetic flux through the two paired excitation teeth is zero. Even with this configuration, because four types of excitation windings, 52, 72, 56, and 76; 53, 73, 57, and 77; 54, 74, 58, and 78; and 55, 75, 59 and 79 correspond to four types of excitation windings 12 and 16; 13 and 17; 14 and 18; and 15 and 19 in the prior art, the permeance change with respect to the motion of the rotor 11 is identical to the prior art, and the position can be detected using the conventional position detection apparatus shown in FIG. 4.

The influence of the leakage magnetic flux on the resolver of FIG. 2 will now be considered. Two excitation teeth in each pair have the same phase for permeance change with respect to the motion of the rotor 11. Because of this, approximately equal leakage magnetic flux goes through each of the excitation teeth in a pair. Therefore, the noise currents generated at the two excitation windings in each pair are at approximately the same level, but have an opposite phase. Because these excitation windings are connected in series, these noise currents will cancel each other out, resulting in removal of the noise current, due to the leakage flux, flowing through the excitation windings in each pair.

A reluctance type resolver has been described in which four signals VCP, VCN, VSP, and VSN having shifted phase are output. In such a resolver, position detection can be performed if two or more signals of different phase are obtained. Therefore, the resolver is not limited to a four-phase outputting reluctance type resolver, but can be a reluctance type resolver which outputs two or three signals having shifted phase. A rotating reluctance type resolver has been described, but the reluctance type resolver is not limited to a rotating type and a linear reluctance resolver having the stator and rotor linearly deployed can also be used.

According to the reluctance type resolver as described, velocity detection and position detection with high precision can be achieved with small influence by the leakage magnetic flux from the permanent magnet of the motor rotor and the electromagnetic brake for control, with a structure that is easy to manufacture, where one winding is wound on one excitation tooth.

What is claimed is:

1. A reluctance type resolver comprising:
a stator, constructed from a magnetic material, having a plurality of excitation teeth, each of which is wound by an excitation winding;
a rotor having magnetic salient sections that are placed to oppose said excitation teeth; and
a detector for detecting the position of said rotor, by detecting a current or voltage of said excitation winding which changes with different phase in response to motion of said rotor; wherein
said excitation winding is wound on each excitation teeth so that the magnetic fluxes through all excitation teeth have the same direction; and
said stator includes bypass magnetic path teeth passing a magnetic flux having a direction opposite to the direction of said excitation teeth.

2. A reluctance type resolver, comprising:
a stator, constructed from a magnetic material, having a plurality of excitation teeth, each of which is wound by an excitation winding;
a rotor having magnetic salient sections that are placed to oppose said excitation teeth; and
a detector for detecting the position of said rotor, by detecting a current or voltage of said excitation winding which changes with different phase in response to the motion of said rotor; wherein
each of said excitation windings is wound on each of the excitation teeth for a pair of adjacent excitation teeth such that the magnetic flux through each of the paired excitation teeth has directions opposite to each other, and said excitation windings for a pair of excitation teeth are connected in series; and
excitation teeth are provided on said stator so that the pitch of each excitation tooth for each pair of adjacent excitation teeth equals an integral multiple of the pitch of the magnetic salient sections of the rotor.
